(19) United States
(12) Patent Application Publication
(10) Pub. No.: US 2005/0195786 A1
(43) Pub. Date: Sep. 8, 2005

(54) Spatial reuse of frequency channels in a WLAN

(75) Inventor: Eran Shpak, Tel Aviv (IL)

Correspondence Address: WELSH & KATZ, LTD, 120 S RIVERSIDE PLAZA, 22ND FLOOR, CHICAGO, IL, 60606, US

(73) Assignee: Extricom Ltd., Tel Aviv (IL)

(21) Appl. No.: 11/112,606

(22) Filed: Apr. 22, 2005

Related U.S. Application Data
(63) Continuation-in-part of application No. 11/072,920, filed on Mar. 3, 2005.
(63) Continuation-in-part of application No. 10/285,869, filed on Nov. 1, 2002, now Pat. No. 6,907,229.
Application No. 10/285,869 is a continuation-in-part of application No. 10/214,271, filed on Aug. 7, 2002.

(51) Int. Cl. H04Q 7/24

(52) U.S. Cl. 370/338

(57) ABSTRACT

A method for communication includes arranging a first plurality of access points, including at least first and second access points, to communicate on a common frequency channel in a wireless local area network (WLAN) with a second plurality of mobile stations, comprising at least first and second mobile stations. The access points are linked to communicate with one another over a communication medium. A message is sent over the communication medium to at least one of the first and second access points so as to cause the first and second access points to simultaneously transmit downlink signals to the first and second mobile stations, respectively. The downlink signals are transmitted simultaneously from the first and second access points responsively to the message.

### CROSS-REFERENCE TO RELATED APPLICATIONS

This application is a continuation-in-part of U.S. patent application Ser. No. 10/285,869, filed Nov. 1, 2002, which is a continuation-in-part of U.S. patent application Ser. No. 10/214,271. This application is also a continuation-in-part of a U.S. patent application entitled “Spatial Reuse of Frequency Channels in a WLAN,” filed Mar. 3, 2005. These related applications are assigned to the assignee of the present patent application, and their disclosures are incorporated herein by reference.

### FIELD OF THE INVENTION

The present invention relates generally to wireless communications, and specifically to methods and devices for improving the performance of wireless local area networks.

### BACKGROUND OF THE INVENTION

Wireless local area networks (WLANs) are gaining in popularity, and new wireless applications are being developed. The original WLAN standards, such as “Bluetooth” and IEEE 802.11, were designed to enable communications at 1-2 Mbps in a band around 2.4 GHz. More recently, IEEE working groups have defined the 802.11a, 802.11b and 802.11g extensions to the original standard, in order to enable higher data rates. The 802.11a standard, for example, envisions data rates up to 54 Mbps over short distances in a 5 GHz band, while 802.11b defines data rates up to 22 Mbps in the 2.4 GHz band. In the context of the present patent application and in the claims, the term “802.11” is used to refer collectively to the original IEEE 802.11 standard and all its variants and extensions, unless specifically noted otherwise.

In a crowded WLAN, multiple stations may attempt to transmit at the same time. If a WLAN receiver receives signals simultaneously from two sources of similar strength on the same frequency channel, it is generally unable to decipher either signal. To deal with this problem, the 802.11 standard (Part 11: Wireless LAN Medium Access Control (MAC) and Physical Layer (PHY) Specifications, ANSI/IEEE Std 802.11, 1999 Edition) provides a distributed coordination function (DCF) for collision avoidance. The DCF is described in section 9.2 of the standard (pages 72-86), which is incorporated herein by reference.

As part of the DCF, a station in the WLAN may transmit a Request-To-Send (RTS) frame, asking to reserve the wireless medium for a subsequent data frame. Typically, the RTS frame is transmitted from a station to an access point, which responds by transmitting a Clear-To-Send (CTS) frame. The formats of the RTS and CTS frames are defined in section 7.2 of the 802.11 standard (pages 41-42), which is also incorporated herein by reference. The RTS and CTS frames specify the MAC address of the requesting station and the duration during which the medium is to be reserved for that station. All other stations receiving the RTS and/or CTS frame are expected to refrain from transmitting during the specified period, regardless of whether the stations belong to the same basic service set (BSS) as the requesting station or to a different BSS.

The 802.11 standard notes that the RTS/CTS mechanism need not be used for every data frame transmission. Because the additional RTS and CTS frames add overhead inefficiency, the mechanism is not always justified, especially for short data frames. In any case, before transmitting any frame, including RTS frames, all stations are required to performing physical carrier sensing, and to back off and refrain from transmission upon determining that the desired transmission channel is in use.

The 802.11 standard also defines an optional contention-free access method called a point coordination function (PCF). The PCF is described in section 9.3 of the standard (pages 86-93), which is also incorporated herein by reference. This access method uses a point coordinator (PC), which operates at the access point of the BSS, to determine which station currently has the right to transmit. The PC thus eliminates contention for a limited period of time, referred to as a contention-free period (CFP). The operation is essentially that of polling, with the PC performing the role of the polling master. When polled by the PC, a station may transmit one packet. The CFP occurs at a defined repetition rate, which is synchronized with periodic transmission of beacons by the access point, as specified in the standard. The CFP alternates with a contention period (CP), during which the DCF controls transmission.

Some WLAN standards provide for transmission power control (also known as “transmit power control,” or TPC). TPC is applied by access points in order to determine the power level of the signals that they transmit to mobile stations. The maximum transmission power level may also be communicated to the mobile stations for application in transmissions to the access points. Typically, in a WLAN, TPC limits the power transmitted by the access point to the minimum needed to reach the farthest mobile station. TPC is mandated for use by access points in the 5 GHz band by IEEE Standard 802.11h, entitled “Spectrum and Transmit Power Management Extensions in the 5 GHz Band in Europe” (publication 802.11h-2003 of the IEEE Standards Department, Piscataway, N.J., July, 2002), which is incorporated herein by reference. TPC in the 5 GHz band is required in some European countries in order to reduce interference with radar. It can also be used for interference reduction, range control and reduction of power consumption by access points and mobile stations.

The above-mentioned U.S. patent application Ser. No. 10/285,869, published as U.S. 2003/0207699 A1, describes a method for enhancing WLAN capacity using transmission power control. The method is implemented in a WLAN system comprising multiple wireless access points distributed within a service region. In order to provide complete coverage of the service region, with strong communication signals throughout the region, the access points are closely spaced. The areas of coverage of the access points, at least when operating at full power, may overlap one another. In order to deal with this overlap, the access points communicate among themselves using a novel protocol over a high-speed, low-latency communication medium. When a mobile station sends an uplink message attempting to initiate communications in a given frequency channel, the access points receiving the message arbitrate among themselves over the medium in order to decide which of the access points will communicate with this mobile station. Problems of overlapping coverage areas and collisions are thus resolved.

After a first access point is chosen by arbitration to begin communicating with a first mobile station, the access point reduces the power level of the downlink signals that it transmits to the mobile station, using a suitable TPC algorithm. Since the “winner” of the arbitration is typically the closest access point to the given mobile station, and the power measurements are available in real time, it is often possible to reduce the transmitted power substantially, with no power-speed tradeoff. The first access point notifies the remaining access points of the periods during which it is transmitting downlink signals to the first mobile station.

Under these conditions, a second access point may determine that the downlink signals from the first access point are sufficiently weak so that the first and second access points can transmit simultaneously, on the same frequency channel, without mutual interference. This determination may be made by the second access point, for example, by detecting the weak signals, identifying the signature of the transmitting access point (in accordance with the applicable standard), and ascertaining that a sufficient signal/interference margin exists for its own transmissions even in the presence of the weak signal. Then, when a second mobile station sends an uplink message, and the second access point wins the arbitration with respect to this second mobile station, the second access point can transmit downlink signals to the second mobile station simultaneously with the downlink transmissions of the first access point to the first mobile station. The second access point applies TPC, as well, in order not to interfere with the transmissions of the first access point.

This cooperative TPC procedure thus enables the access points to divide the WLAN into dynamic, non-interfering domains (referred to in U.S. 2003/0207699 A1 as “sub-networks”). This domain structure allows frequency channels to be spatially reused among the access points, thereby increasing the capacity of the WLAN.

### SUMMARY OF THE INVENTION

Embodiments of the present invention build on and improve upon the spatial reuse methods described in the above-mentioned U.S. patent application Ser. No. 10/285,869. The access point that is to communicate with each of the stations in the WLAN is assigned by arbitration among the access points themselves or, alternatively, by a centralized access manager function. When it is determined that certain access points may communicate with their assigned stations without excessive mutual interference (subject to appropriate control of transmission power), a message is sent over a communication medium linking the access points so as to cause these access points to simultaneously transmit downlink signals to their respective stations. Each station receives the downlink signal sent by its assigned access point, while ignoring the downlink signal transmitted simultaneously by the other, more distant access point, even though both signals are transmitted on the same frequency channel and may share the same BSS.

In accordance with the 802.11 standard, immediately after the mobile stations receive the downlink signals, they transmit uplink acknowledgment (ACK) messages. Because the stations may transmit these uplink signals at higher power than the downlink transmissions of the access points, the access points may receive both uplink signals simultaneously and may therefore be unable to decode the ACK messages. Furthermore, ACK packets (as defined in the 802.11 standard) do not identify the packet source. Therefore, if the access points succeed in receiving only one ACK packet, it is not possible to determine from the content of the ACK packet which mobile station acknowledged the downlink signal and which did not. To avoid these problems, the simultaneous downlink transmissions by the access points may be controlled so that the ends of the downlink messages are offset in time. Consequently, the ACK messages will be similarly offset, and can thus be distinguished by their arrival times at the access points.

In some embodiments of the present invention, two or more access points, in different parts of the WLAN, are each assigned to communicate with a respective group of stations. The access manager instructs each of the access points to communicate with the stations in its group in sequence, in such a way that one station in each group communicates with the access point to which it is assigned simultaneously with one of the stations in the other group. The access manager thus enforces a sort of time division multiplexing (TDM) among the stations in each group, which may be synchronized across two or more groups. This scheme is useful particularly in reducing latency and jitter in real-time applications, such as Voice over Internet Protocol (VoIP), that involve regular transmission of fixed-length data packets, but it may be used to enhance the capacity of the WLAN in transmission of all sorts of application traffic.

There is therefore provided, in accordance with an embodiment of the present invention, a method for communication, including:
arranging a first plurality of access points, including at least first and second access points, to communicate on a common frequency channel in a wireless local area network (WLAN) with a second plurality of mobile stations, including at least first and second mobile stations;
linking the access points to communicate with one another over a communication medium;
sending a message over the communication medium to at least one of the first and second access points so as to cause the first and second access points to simultaneously transmit downlink signals to the first and second mobile stations, respectively; and
transmitting the downlink signals simultaneously from the first and second access points responsively to the message.

In a disclosed embodiment, assigning the first plurality of the access points includes assigning at least the first and second access points to a common Basic Service Set (BSS).

Typically, the access points have respective service areas within a region served by the WLAN, and the access points are arranged so that at least some of the service areas substantially overlap. In some embodiments, sending the message includes partitioning the region served by the WLAN so as to define non-overlapping first and second sub-regions served respectively by the first and second access points. Transmitting the downlink signals includes applying transmit power control (TPC) at the first and second access points so as to limit reception of the downlink signals to the first and second sub-regions, respectively.

In disclosed embodiments, transmitting the downlink signals includes generating the downlink signals in accordance with IEEE Standard 802.11.

In some embodiments, the method includes receiving first and second acknowledgment (ACK) frames from the first and second mobile stations responsively to the downlink signals, and transmitting the downlink signals simultaneously includes transmitting first and second downlink frames from the first and second access points, respectively, so as to cause a time offset between the first and second ACK frames. In one embodiment, transmitting the first and second downlink frames includes delaying a start of transmission of the second downlink frame relative to the first downlink frame. In an alternative embodiment, transmitting the first and second downlink frames includes padding the second downlink frame so that transmission of the second downlink frame finishes later than the first downlink frame.

In a disclosed embodiment, arranging the first plurality of the access points includes grouping at least a portion of the mobile stations into at least first and second multiplexing groups, which are respectively assigned to the first and second access points, and allocating respective time slots to the mobile stations in each of the groups, and transmitting the downlink signals includes prompting the mobile stations in the first and second multiplexing groups to transmit uplink signals simultaneously during the respective time slots. Optionally, prompting the mobile stations includes sending unsolicited Clear To Send (CTS) messages simultaneously from the first and second access points to the first and second mobile stations.

There is also provided, in accordance with an embodiment of the present invention, apparatus for communication, including:
a first plurality of access points, including at least first and second access points, which are arranged to communicate on a common frequency channel in a wireless local area network (WLAN) with a second plurality of mobile stations, including at least first and second mobile stations; and
an access manager, which is coupled to send a message over a communication medium to at least one of the first and second access points so as to cause the first and second access points to simultaneously transmit downlink signals to the first and second mobile stations, respectively.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a WLAN system with TPC, in accordance with an embodiment of the present invention;

FIGS. 2 and 3 are timing diagrams that schematically illustrate methods for simultaneously downlink transmission by two access points in a WLAN, in accordance with embodiments of the present invention; and

FIG. 4 is a timing diagram that schematically illustrates a time division multiplexing scheme (TDM) used in a WLAN, in accordance with an embodiment of the present invention.

### DETAILED DESCRIPTION OF EMBODIMENTS

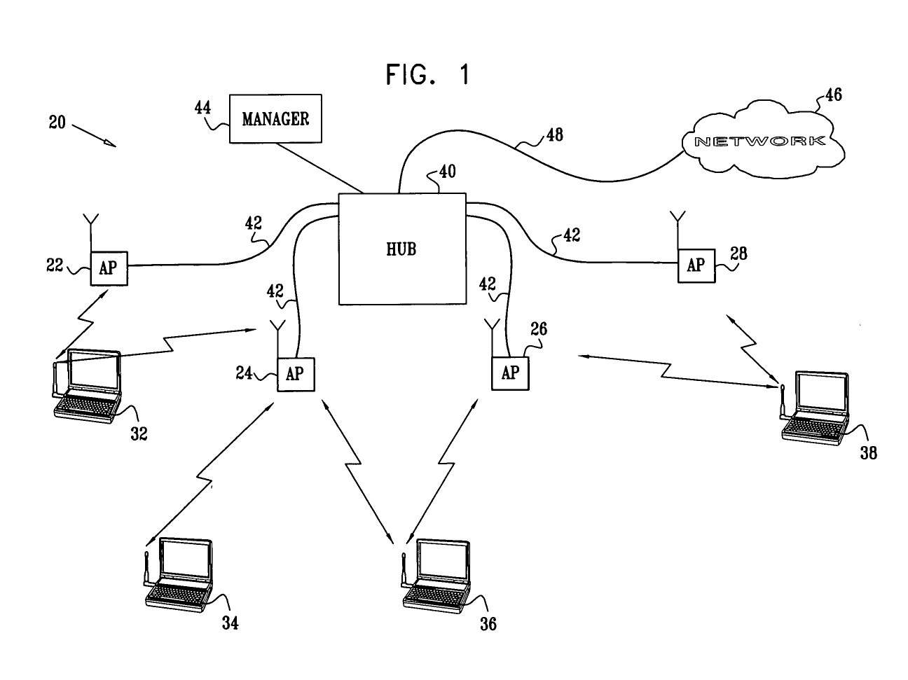

FIG. 1 is a block diagram that schematically illustrates a wireless LAN (WLAN) system 20, in accordance with a preferred embodiment of the present invention. System 20 comprises multiple access points 22, 24, 26, 28, which comprise PHY and MAC interfaces for data communication with mobile stations 32, 34, 36, 38. The mobile stations typically comprise computing devices, such as desktop, portable or handheld devices. In the exemplary embodiments described hereinbelow, it is assumed that the access points and mobile stations communicate with one another in accordance with one of the standards in the IEEE 802.11 family and observe the 802.11 MAC layer conventions described in the above-mentioned 802.11 standard. The principles of the present invention, however, may also be applied, mutatis mutandis, in other wireless environments, such as Bluetooth networks, personal area networks (IEEE 802.15), wireless metropolitan area networks (IEEE 802.16) and Ultra Wideband (UWB) networks.

The access points are interconnected by a communication medium, typically comprising a wired LAN 42 with a hub 40, such as an Ethernet switching hub. LAN 42 serves as the distribution system (DS) for exchanging data between the access points and the hub. Typically, the hub is also linked to an external network 46, such as the Internet, via an access line 48, so as to enable the mobile stations to send and receive data through the access points to and from the external network.

An access manager 44 controls downlink transmissions by access points 22, 24, 26, 28 in order to enhance the coverage and performance of the WLAN system. The access points may have overlapping service areas and operate on the same frequency channel and share the same BSS identifier (BSSID). Manager 44 selects one of the access points to communicate with each mobile station (usually the closest access point to the mobile station). Techniques that may be used for this purpose are described, for example, in U.S. Pat. No. 6,799,054 and in U.S. Patent Application Publications U.S. 2003/0206532 A1, U.S. 2004/0063455 A1 and U.S. 2004/0156399 A1, whose disclosures are incorporated herein by reference.

For conceptual clarity, manager 44 is shown as a separate unit within the system, coupled to hub 40. In practice, the function of manager 44 may be integrated into the hub or into one of the access points, or distributed among the access points (assuming the hub or access points to have suitable processing resources for carrying out this function). Although embodiments of the present invention may require certain modifications to the functionality of conventional 802.11 access points to perform the operations described herein, the novel operation of the access points and of manager 44 is transparent to mobile stations 32, 34, 36, 38, which operate in accordance with the 802.11 standard without modification.

For the sake of the description that follows, it is assumed that access points 22, 24, 26 and 28 all transmit and receive signals on the same frequency channel, to which mobile stations 32, 34, 36 and 38 are likewise tuned. Typically, the WLAN system may include additional access points operating on other frequency channels, but these additional access points do not interfere with communications on the frequency channel of access points 22,24, 26 and 28, and therefore are not of concern here. Rather, the methods of access point control and collaboration provided by the present invention, as described hereinbelow with reference to access points 22, 24, 26 and 28, may be carried out independently by the set of access points on each of the operative frequency channels in the WLAN system.

Downlink signals transmitted at full power by any of access points 22, 24, 26 and 28 can, in principle, be received by any of mobile stations 32, 34, 36 and 38. In WLAN systems known in the art, if adjacent access points 22 and 24 were to transmit simultaneously on the same frequency channel, for example, mobile station 32 would receive downlink signals from both access points. This overlap would probably result in inability of the mobile station to communicate with any of the access points. In embodiments of the present invention, however, the access points communicate with manager over LAN 42 in order to resolve this conflict using a MAC-level collaboration protocol, as described in the above-mentioned patent applications. Alternatively, the access points may arbitrate among themselves without intervention of a centralized manager function. Further alternatively or additionally, the access points may communicate for purposes of MAC-level collaboration over a dedicated communication medium. These alternative communication and control options are described, for example, in the above-mentioned U.S. Patent Application Publication U.S. 2003/0207699 A1 and in U.S. Patent Application Publication U.S. 2003/0206532 A1, whose disclosure is also incorporated herein by reference.

The MAC-level collaboration protocol of the present invention allows the access points to dynamically define portions of the service area of system 20 as spatial domains, using methods described in U.S. Patent Application Publication U.S. 2003/0207699 A1. By way of example, after mobile station 32 has exchanged association messages with access point 22 (as required in order to begin communications under the 802.11 standards), access point 22 uses transmit power control (TPC) to reduce its transmission power in downlink messages to mobile station 32. The power is typically reduced to a minimum level that will allow the mobile station to receive the downlink messages reliably at the highest possible speed.

At this transmission power level of access point 22, nearby access point 24 and mobile station 34 may still receive the downlink messages from access point 22, but access point 28 and mobile station 38 will not. Therefore, if mobile station 38 becomes associated with access point 28, for example, it is then possible for access point 28 to transmit downlink messages to mobile station 38, with power level reduced by TPC, simultaneously with the downlink transmission by access point 22 to mobile station 32. System 20 is thus partitioned dynamically into two virtual domains, each with its own service sub-region, operating simultaneously. Larger numbers of simultaneous domains may be defined in like fashion. These domains are used when the participating access points transmit downlink signals at low power to nearby mobile stations. Such simultaneous downlink communications may be inhibited at other times. Furthermore, the membership of the domains may be modified dynamically due to movement of mobile stations or other changes in network conditions.

To maximize the efficiency of use of the wireless medium in WLAN 20, manager 44 typically instructs the access points in different domains to transmit downlink messages simultaneously. In the context of the present patent application and in the claims, the term “simultaneous” is used to refer to transmissions that overlap in time, but does not require that the transmission either begin or end at the same time.

Because the 802.11 standard requires a station receiving a transmission to respond promptly with an ACK frame, if access points 22 and 28 transmit downlink frames to mobile stations 32 and 38 that end at the same time, the mobile stations will typically transmit uplink ACK frames at the same time. Although in some systems the access points may indicate to the mobile stations the maximum transmission power that they may use generally for uplink signals, the control they exert over the uplink power is not as fine as the TPC that the access points apply to their own downlink signals. Therefore, the uplink ACK signals may be strong enough so that the access points will receive both ACK signals simultaneously, with comparable power levels. As a result of this collision, the access points may be unable to decode either ACK frame. Furthermore, even if the access points succeed in decoding one of the ACK frames, it is not possible to determine from the contents of the ACK frame which of the mobile stations sent it. Consequently, the access points (or manager 44) may conclude that one or both downlink frames was not received and may unnecessarily retransmit the frames. These problems are resolved by the embodiments that follow.

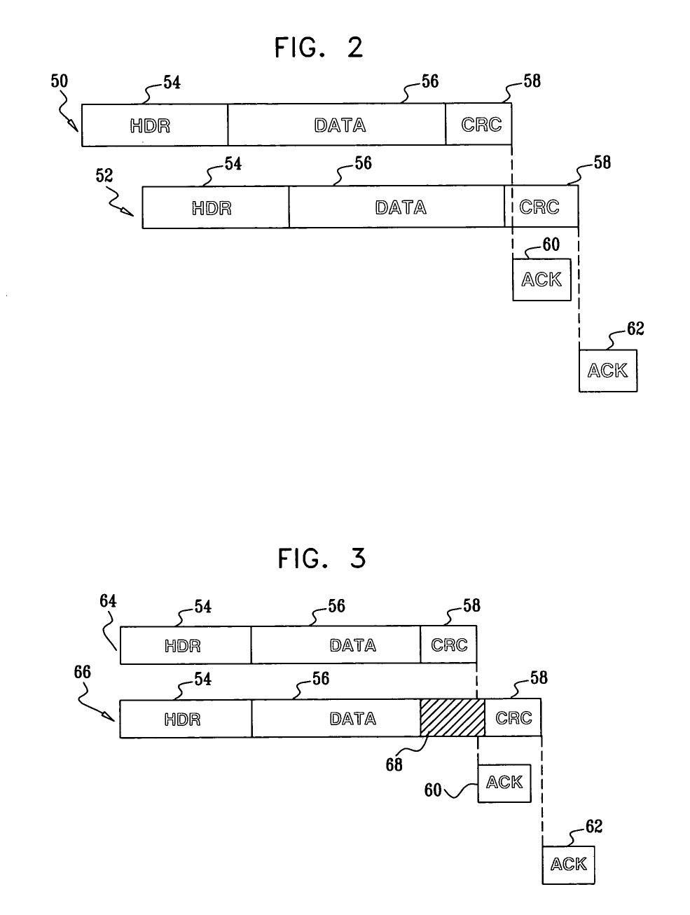

FIG. 2 is a timing diagram that schematically illustrates frames transmitted in WLAN 20, in accordance with an embodiment of the present invention. The diagram illustrates one possible scheme for avoiding the problem of overlapping uplink ACK frames. In this example, it is assumed that access points 22 and 28 are assigned to transmit respective downlink frames 50 and 52, which are of equal lengths. Each frame comprises a header 54, data payload 56 and frame-check sequence 58, typically in the form of a cyclic redundancy code (CRC), as mandated by the 802.11 standard. Stations 32 and 38 respond with respective ACK frames 60 and 62. To avoid the problem of uplink collisions, manager 44 instructs one of the access points (in this case, access point 28) to delay transmission of downlink frame 52 by a sufficient length of time so that ACK frame 62 does not overlap with ACK frame 60. Typically, in the 802.11 environment, a relative delay of about 10 μs is sufficient for this purpose. Alternatively, a larger or smaller delay is possible, depending on protocol requirements.

Header 54 comprises both PHY and MAC headers, wherein the PHY header begins with a preamble for purposes of synchronization by the receiving station. The length of the preamble varies depending on whether orthogonal frequency-division multiplexing (OFDM) or complementary code keying (CCK) is used in modulating the data in the frame. CCK frames have a long preamble (96 or 192 μs). Therefore, station 38 will still be able to decode frame 52, notwithstanding the offset of about 10 μs, without loss of information. OFDM frames, however, have a much shorter preamble (typically 16 μs), and the 10 μs delay may therefore leave station 38 with an insufficient period of clear reception of the preamble of frame 52 in order to properly synchronize reception of this frame. If the delay is longer, however, station 38 may synchronize on frame 50 and then ignore frame 52.

FIG. 3 is a timing diagram that schematically illustrates frames 64 and 66 transmitted in WLAN 20, in accordance with an alternative embodiment of the present invention. In this case, the problem of overlapping ACK frames is avoided by delaying the end of one of the downlink frames, rather than the beginning. This scheme is more appropriate for OFDM modulation, in which headers 54 comprise only a short preamble. In the example shown in FIG. 3, access points 22 and 28 begin transmitting frames 64 and 66, respectively, at the same time, but padding bits 68 are added to the end of data payload 56 of frame 66, so that frame 66 ends at least about 10 μs later than frame 64. Station 38 therefore sends ACK frame 62 at least 10 μs later than ACK frame 60.

Padding bits 68 are appended to data payload 56 by access point 28 (or alternatively, by manager 44), without changing the existing contents of the data payload. Typically, the payload comprises a Layer 3 data packet (such as an Internet protocol [IP] packet), including a protocol header that specifies the data length. Since the padding bits are outside the length specified by the Layer 3 header, the application on station 38 that receives payload 56 simply discards padding 68.

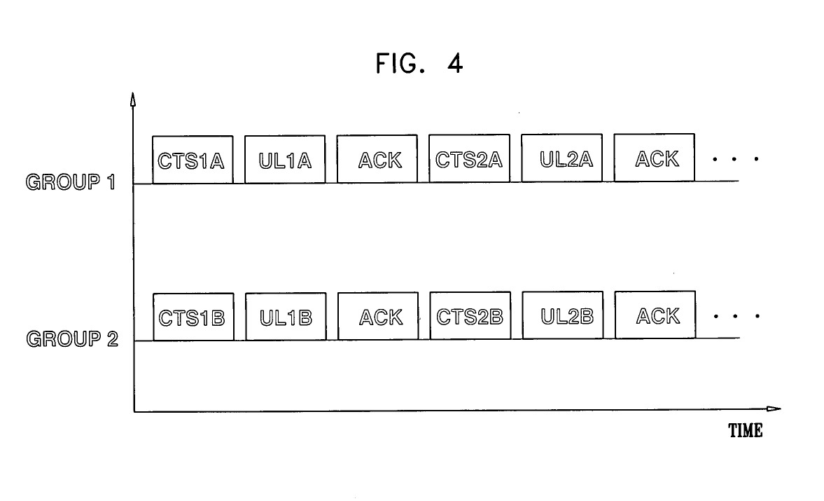

FIG. 4 is a timing diagram that schematically illustrates a time division multiplexing (TDM) scheme used in a WLAN, in accordance with an embodiment of the present invention. This embodiment uses unsolicited CTS frames to support the uplink TDM scheme, as described in the above-mentioned U.S. patent application entitled “Spatial reuse of frequency channels in a WLAN.” Each CTS frame specifies the station that is to transmit the next uplink signal, along with the time interval during which the selected station may transmit. Upon receiving the CTS frame, if the station specified in the message has data to transmit, the station will transmit at least one uplink frame during the time interval in accordance with the 802.11 standard, even if the station did not previously transmit a RTS frame. All other stations (even stations in another BSS) refrain from transmission. The access point receiving the uplink data frame responds with an ACK frame, as specified by the standard.

In the scenario illustrated in FIG. 4, it is assumed that manager 44 has partitioned WLAN 20 into two dynamic domains, each containing a different multiplexing group of the mobile stations. For example, Group A might include mobile stations 32 and 34, which communicate with access point 22, while Group B includes mobile stations 36 and 38, which communicate with access point 28. Alternatively, manager 44 may partition the WLAN into a larger number of domains and may define more than two simultaneous multiplexing groups and/or may include more than two mobile stations in each multiplexing group. The access points serving the different domains apply TPC, as described above, in order to avoid interference between the multiplexing groups, even while both groups use the same frequency channel and BSSID.

Each access point begins the TDM pattern by transmitting an unsolicited CTS frame, labeled CTS1A or CTS1B, to the mobile stations in its group. Each of these frames specifies the MAC address of the first mobile station in the respective group. (The order of mobile stations in each group is arbitrary.) Each CTS frame defines a time slot, during which the specified mobile stations then transmit respective uplink data frames: UL1A and UL1B. These frames are acknowledged by the respective access points with an ACK frame. (In reality, the duration of the uplink transmission is generally much longer than the CTS and ACK frames, but the relative lengths of the uplink transmissions are compressed in FIG. 4 for convenience of illustration.) The access points then go on to transmit CTS frames CTS2A and CTS2B, each specifying the MAC address of the second mobile station in the group. The appropriate mobile stations then transmit uplink data frames UL2A and UL2B, and the process continues until all the eligible mobile stations have had their turn.

Subsequently, the access points transmit simultaneous downlink data frames to each of the respective mobile stations in turn. This TDM pattern continues with successive, multiplexed uplink and downlink time slots. Manager 44 may also instruct the access points to refrain from this sort of TDM transmission for a certain period of time, during which the stations in the WLAN are free to access the wireless medium using the conventional contention-based access methods provided by the DCF of the 802.11 standard. Thus, the dwell time (i.e., the period between successive beacon transmissions) of the access points is divided between TDM and contention-based access periods.

As noted earlier, the TDM pattern exemplified by FIG. 4 is useful for real-time applications, and particularly applications involving duplex transmission, such as voice and video conferencing. Manager 44 determines which mobile stations to assign to each group depending generally on the strengths of the uplink signals received by different access points from each of the mobile stations, and possibly on other network management considerations. The manager may read and analyze the payload data of uplink frames from the mobile stations in order to detect real-time application traffic and thus assign mobile stations running real-time applications (such as VoIP) to a multiplexing group. Mobile stations running data applications, such as Web browsing or e-mail, may be assigned to the domain of one of the access points without receiving specific TDM slots.

Although the embodiment described above makes use of the novel unsolicited CTS mechanism, a similar sort of TDM scheme may be implemented using the PCF mechanism defined by the 802.11 standard, as described in the Background of the Invention. In contrast to the conventional PCF implementation, however, which permits only a single PC in a given BSS, embodiments of the present invention permit the partitioning of WLAN into two or more multiplexing groups, operating on the same frequency channel simultaneously, typically with the same BSS. Manager 44 directs each of access points 22 and 28 to serve as the PC for its own domain during the TDM portion of the dwell time.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
arranging a first plurality of access points, comprising at least first and second access points, to communicate on a common frequency channel in a wireless local area network (WLAN) with a second plurality of mobile stations, comprising at least first and second mobile stations;
linking the access points to communicate with one another over a communication medium;
sending a message over the communication medium to at least one of the first and second access points so as to cause the first and second access points to simultaneously transmit downlink signals to the first and second mobile stations, respectively; and
transmitting the downlink signals simultaneously from the first and second access points responsively to the message.

2. The method according to claim 1, wherein assigning the first plurality of the access points comprises assigning at least the first and second access points to a common Basic Service Set (BSS).

3. The method according to claim 1, wherein the access points have respective service areas within a region served by the WLAN, and wherein the access points are arranged so that at least some of the service areas substantially overlap.

4. The method according to claim 3, wherein sending the message comprises partitioning the region served by the WLAN so as to define non-overlapping first and second sub-regions served respectively by the first and second access points.

5. The method according to claim 4, wherein transmitting the downlink signals comprises applying transmit power control (TPC) at the first and second access points so as to limit reception of the downlink signals to the first and second sub-regions, respectively.

6. The method according to claim 1, wherein transmitting the downlink signals comprises generating the downlink signals in accordance with IEEE Standard 802.11.

7. The method according to claim 1, and comprising receiving first and second acknowledgment (ACK) frames from the first and second mobile stations responsively to the downlink signals, and wherein transmitting the downlink signals simultaneously comprises transmitting first and second downlink frames from the first and second access points, respectively, so as to cause a time offset between the first and second ACK frames.

8. The method according to claim 7, wherein transmitting the first and second downlink frames comprises delaying a start of transmission of the second downlink frame relative to the first downlink frame.

9. The method according to claim 7, wherein transmitting the first and second downlink frames comprises padding the second downlink frame so that transmission of the second downlink frame finishes later than the first downlink frame.

10. The method according to claim 1, wherein arranging the first plurality of the access points comprises grouping at least a portion of the mobile stations into at least first and second multiplexing groups, which are respectively assigned to the first and second access points, and allocating respective time slots to the mobile stations in each of the groups, and
wherein transmitting the downlink signals comprises prompting the mobile stations in the first and second multiplexing groups to transmit uplink signals simultaneously during the respective time slots.

11. The method according to claim 10, wherein prompting the mobile stations comprises sending unsolicited Clear To Send (CTS) messages simultaneously from the first and second access points to the first and second mobile stations.

12. Apparatus for communication, comprising:
a first plurality of access points, comprising at least first and second access points, which are arranged to communicate on a common frequency channel in a wireless local area network (WLAN) with a second plurality of mobile stations, including at least first and second mobile stations; and
an access manager, which is coupled to send a message over a communication medium to at least one of the first and second access points so as to cause the first and second access points to simultaneously transmit downlink signals to the first and second mobile stations, respectively.

13. The apparatus according to claim 12, wherein at least the first and second access points are assigned to a common Basic Service Set (BSS).

14. The apparatus according to claim 12, wherein the access points have respective service areas within a region served by the WLAN, and wherein the access points are arranged so that at least some of the service areas substantially overlap.

15. The apparatus according to claim 14, wherein the access manager is operative to partition the region served by the WLAN so as to define non-overlapping first and second sub-regions served respectively by the first and second access points.

16. The apparatus according to claim 15, wherein the first and second access points are configured to apply transmit power control (TPC) so as to limit reception of the downlink signals to the first and second sub-regions, respectively.

17. The apparatus according to claim 12, wherein the access points are configured to transmit the downlink signals in accordance with IEEE Standard 802.11.

18. The apparatus according to claim 12, wherein the access manager is adapted to instruct the first and second access points to transmit first and second downlink frames, respectively, so as to cause a time offset between first and second acknowledgment (ACK) frames received from the first and second mobile stations, respectively, responsively to the downlink signals.

19. The apparatus according to claim 18, wherein the access manager is adapted to instruct the second access point to delay a start of transmission of the second downlink frame relative to the first downlink frame so as to cause the time offset between the first and second ACK frames.

20. The apparatus according to claim 18, wherein the access manager is adapted to cause the second downlink frame to be padded so that transmission of the second downlink frame finishes later than the first downlink frame.

21. The apparatus according to claim 12, wherein the access manager is adapted to group at least a portion of the mobile stations into at least first and second multiplexing groups, which are respectively assigned to the first and second access points, and to allocate respective time slots to the mobile stations in each of the groups, and to cause the first and second access points to prompt the mobile stations in the first and second multiplexing groups, respectively, to transmit uplink signals simultaneously during the respective time slots.

22. The apparatus according to claim 21, wherein the access manager is adapted to instruct the first and second access points to prompt the first and second access points by sending unsolicited Clear To Send (CTS) messages simultaneously to the first and second mobile stations.
